(19) United States
(12) Patent Application Publication
(10) Pub. No.: US 2014/0351242 A1
(43) Pub. Date: Nov. 27, 2014

(54) SYSTEM AND METHOD FOR SEARCHING ELEMENTS IN A USER INTERFACE

(71) Applicant: Christopher Stephen Burns, Valley Village, CA (US)

(72) Inventor: Christopher Stephen Burns, Valley Village, CA (US)

(73) Assignee: THOMSON LICENSING, Issy de Moulineaux (FR)

(21) Appl. No.: 14/232,001

(22) PCT Filed: Jul. 26, 2012
(86) PCT No.: PCT/US12/48237

§ 371 Date: Jul. 22, 2014

Related U.S. Application Data
(60) Provisional application No. 61/572,995, filed on Jul. 26, 2011.

(51) Int. Cl. G06F 17/30; G06F 3/0482; G06F 3/0484

(52) U.S. Cl. CPC G06F 17/30424; G06F 3/04842; G06F 3/0482
USPC 707/722

(57) ABSTRACT

The disclosed methods and systems are related to searching elements of user interfaces. Without leaving the displayed user interface, such as an on-screen guide, searches can be performed on elements of the user interface, and the results of the searches may displayed in the same user interface.

### CROSS REFERENCE TO RELATED APPLICATIONS

This application claims the benefit of U.S. Provisional Application Ser. No. 61/572,995 filed Jul. 26, 2011, which is incorporated by reference herein in their entirety.

### BACKGROUND

1. Technical Field

This invention relates to the field of user interfaces. More particularly, this invention relates to the searching of visual elements of a user interface.

2. Description of Related Art

Currently, the approach to searching for information, for example, in the television user interface space, is to invoke an on-screen keyboard (or have a keyboard enabled input device), then manually type in the desired search terms to initiate the search. There are three problems with this approach. First, on-screen keyboards are difficult and slow to use. Second, this approach pulls the user out of the context of his current task, forcing him into another screen and mindset. Third, the navigation of an on-screen keyboard with a typical TV remote (i.e. Up/Down/Left/Right directional arrows) is cumbersome at best. Disadvantages and weaknesses include cumbersome usability, slow process to initiate search, and too many screens to navigate in order to perform a search.

### SUMMARY

The disclosed embodiments are related to a system and method that provides a user with the ability to automatically select a term to search for, which could be a word, phrase, or even image within a displayed user interface. This is achieved by either direct interaction with text on the screen (as in a touch-based UI where the user merely touches a word to kick off the search) or with an image (this would initiate an image-recognition search based on the data contained in the selected image). This provides a more intuitive, seamless experience to the search function, allowing the user to maintain the context of the activity the user is currently engaged in, while still allowing the user to enjoy the benefits provided by search capability.

In accordance with one embodiment of the present disclosure method is provided for searching elements of a user interface. The method involves providing a user interface comprising one or more selectable elements for display, receiving a selection of a selectable displayed element of the user interface, performing a search on the selected element, and providing the results of the search as part of the user interface for display.

In accordance with another embodiment of the present disclosure a system is provided allowing for the searching of elements of a user interface. The system includes an electronic device. The electronic device includes an output interface, an input interface, a processor, and storage. The output interface is configured to output a user interface. The input interface is configured to receive a selection of a selectable element of the user interface. The processor configured to generate selectable elements in the user interface, perform a search on a received selection of a selectable element, and provide the results the results of the search as part of the user interface. The storage is configured to store information regarding the selectable elements, search, and results.

### BRIEF DESCRIPTION OF THE DRAWINGS

FIG. 1A is a diagram depicting an embodiment of a system having separate components in accordance with one embodiment.

FIG. 1B is a diagram depicting an embodiment of a system wherein the different components are incorporated into one unit in accordance with one embodiment.

FIG. 2 is a block diagram depicting the elements of a system in accordance with one embodiment.

FIG. 3 is a flow diagram illustrating a methodology in accordance with one embodiment.

FIG. 4 is an exemplary program guide displayed as part of a user interface in accordance with one embodiment.

FIG. 5 depicts one example of a user interacting with the displayed program guide of FIG. 5 in accordance with one embodiment.

FIG. 6 is an exemplary details screen having selectable searchable elements in accordance with one embodiment.

FIG. 7 depicts one example of a user interacting with the selectable elements of the displayed details screen of FIG. 6 in accordance with one embodiment.

FIG. 8 is an exemplary details screen including the display of the results of a search of a selected selectable element in accordance with one embodiment.

FIG. 9 depicts one example of a user interacting with the displayed search results of the displayed details screen of FIG. 8 in accordance with one embodiment.

FIG. 10 is an exemplary search result details screen displayed as part of a user interface in accordance with one embodiment.

### DETAILED DESCRIPTION

The methodologies, systems and teachings disclosed herein can be embodied in an electronic device that is capable of generating or otherwise providing a user interface, receiving selections of elements to be searched, and providing the search results to be displayed in the user interface. Examples of such electronic devices include, but are not limited to, personal computers, set-top boxes, televisions, media players, gaming devices, and the like.

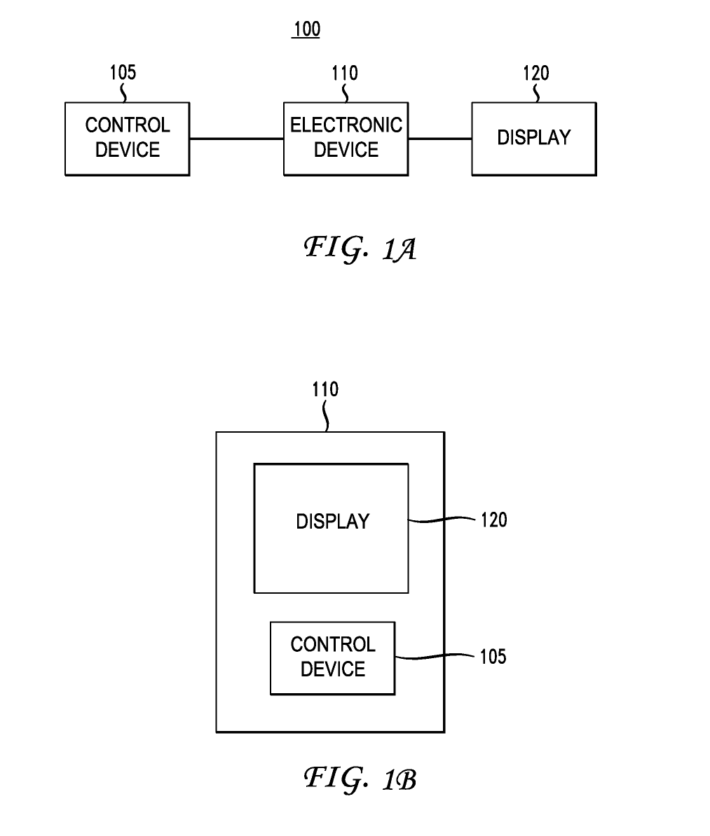

FIG. 1A depicts one system 100 in which the functionality described herein can be employed. In this example there are three main components: a control device 105, a electronic device 110, and a display 120. In this embodiment, the electronic device 110 may be a set top box, such as a media player or a personal computer that is designed to be connected to a control device 105 and a display 120. The control device may be remote control, touch-pad, mouse, or the like. The control device 105 may be connected to the electronic device 110 through a wired connection, such as a USB or network cable, or a wireless connection such as: Infrared (IR), Radio Frequency (RF), Bluetooth (BT), or wireless networking protocol (WiFi). The display 120 can be any display capable of displaying a user interface such as a Cathode Ray Tube (CRT), Plasma, Liquid Crystal Display (LCD), Organic Light Emitting Diode (OLED), or the like. The connection between the electronic device 110 and the display 120 can be a coaxial, RCA, VGA, DisplayPort, DVI, HDMI or other type of connection.

While in the embodiment of FIG. 1A the control device 105, electronic device, and display 110 are depicted as separate devices, in many embodiments, one or more of these components may be combined. An example of this can be seen in FIG. 1B. FIG. 1B depicts an electronic device 110 that includes the control device 105 and the display 120. Examples of such electronic devices include, but are not limited to, laptops, personal media players, ebook readers, personal gaming systems, test equipment, and the like.

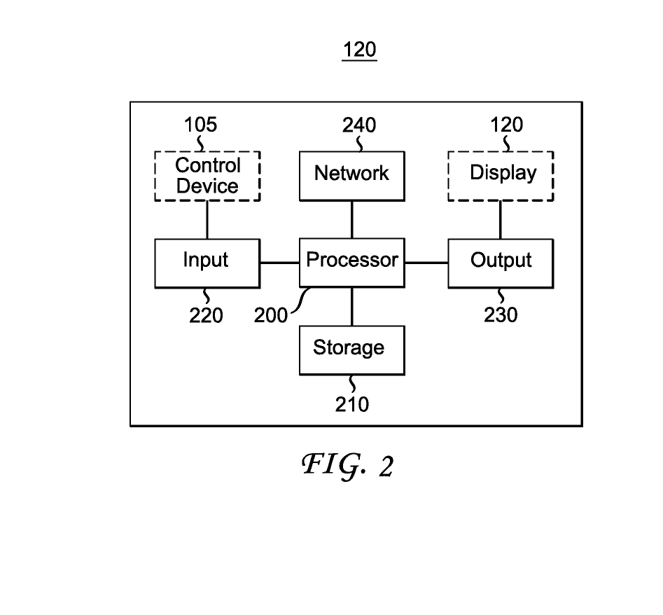

FIG. 2 is a block diagram depicting the elements of electronic device 110 in accordance with one embodiment. In this embodiment, the media player 110 comprises a processor 200, storage 210, input interface 220, an output interface 230, and a network interface 240. Each of these elements will be discussed in more detail below.

The processor 200 controls the operation of the electronic device 110. The processor 200 runs the software that operates the electronic device 110 as well as provides the functionality of the present invention. The processor 200 is connected to storage 210, input interface 220, and output interface 230, and, in some embodiments, network interface 240, and handles the transfer and processing of information between these elements. The processor 200 can be general processor or a processor dedicated for a specific functionality. In certain embodiments there can be multiple processors or multiple cores.

The storage 210 is where the software and other information used by the electronic device 110 are stored. The storage 210 can include volatile memory (RAM), non-volatile memory (EEPROM), magnetic media (hard drive), optical media (CD/DVD-Rom), or flash based storage. In certain embodiments the storage 210 will typically include memory as well as large capacity storage such as a hard-drive.

The input interface 220 allows the user to interact with the electronic device 110. The input interface 220 handles the interfacing with the various devices that can be used to input information, such as the control device 105.

The output interface 230 is configured to provide the media in the correct format for outputting on the display 120. The proper format can include the codec for the content to be output as well as the connector type used to connect to an external video display device or an audio device or in some embodiments, the onboard display or speakers. The output interface 230 may also provide the user interface having selectable elements that can be selected by a user for searching.

In certain other embodiments the electronic device 110 may also include the control device 105 and display 120 such as depicted in FIG. 1B. In the example shown in FIG. 2, the control device 105 is connected to the input interface 220 and the display 120 is connected to the output interface 230.

The electronic device 110 also includes a network interface 240. The network interface 240 handles the communication of the electronic device 110 with other devices over a network. Examples of networks include Ethernet or multimedia over coaxial (MoCa) networks. Other types of networks will be apparent to one skilled in the art given the benefit of this disclosure.

It should be understood that the elements set forth in FIG. 2 are illustrative. The electronic device 110 can include any number of elements and certain elements can provide part or all of the functionality of other elements. For example, the much of the functionality of the input interface 220 and output interface 230 can be performed by the processor 200 or multiple general or dedicated processors. Likewise, network connectively can be implemented as part of or separate from either the output interface 230 or the input interface 220. Other possible implementation will be apparent to on skilled in the art given the benefit of this disclosure.

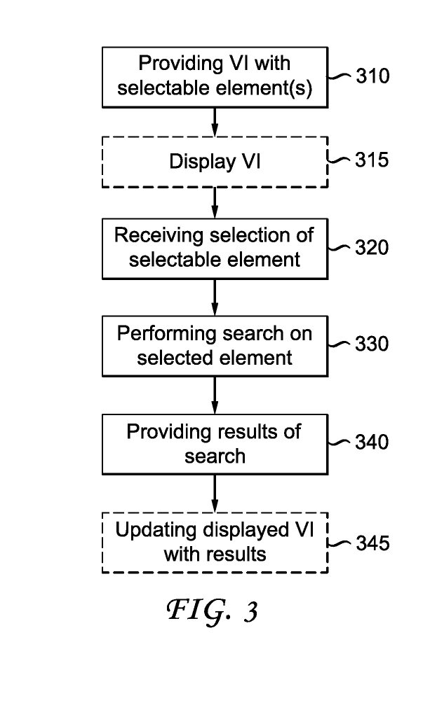

FIG. 3 is a flow diagram depicting a method 300 for the searching of selectable items in a user interface. At its most basic, the method involves four steps. The first step is providing a user interface (UI) having one or more selectable elements (step 310). A selection of a selectable element of the user interface is then received (step 320). A search on the selected element is them performed (step 330). Finally, the results of the performed search are provided (340). In certain embodiments, the method can further include the steps of displaying the user interface (step 315) and updating the displayed user interface to reflect the provided search results.(step 345). Each of these steps will be discussed in more detail below.

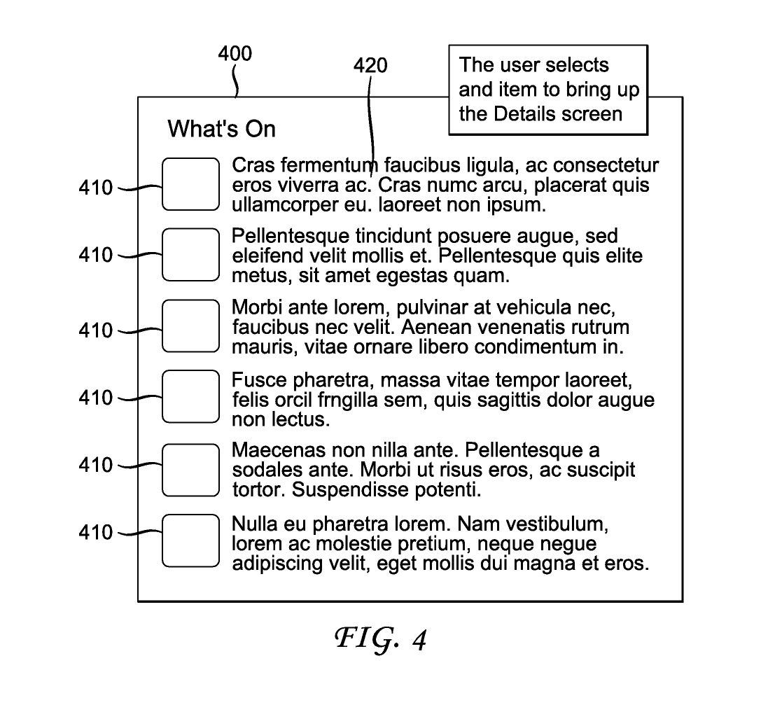

The providing of a user interface having one or more selectable elements (step 310) involves the processor 200 generating the user interface having selectable elements, the output interface 230 outputting the user interface to a display 120 on which the user interface can be displayed (step 315) on a display device 120. In one embodiment, the user interface is a graphical user interface, such as an electronic program guide (EPG). In such user interface displays, a details screen can be provided to provide relevant information about selected content. An example of one embodiment of a provided user interface can be seen in FIGS. 4-6.

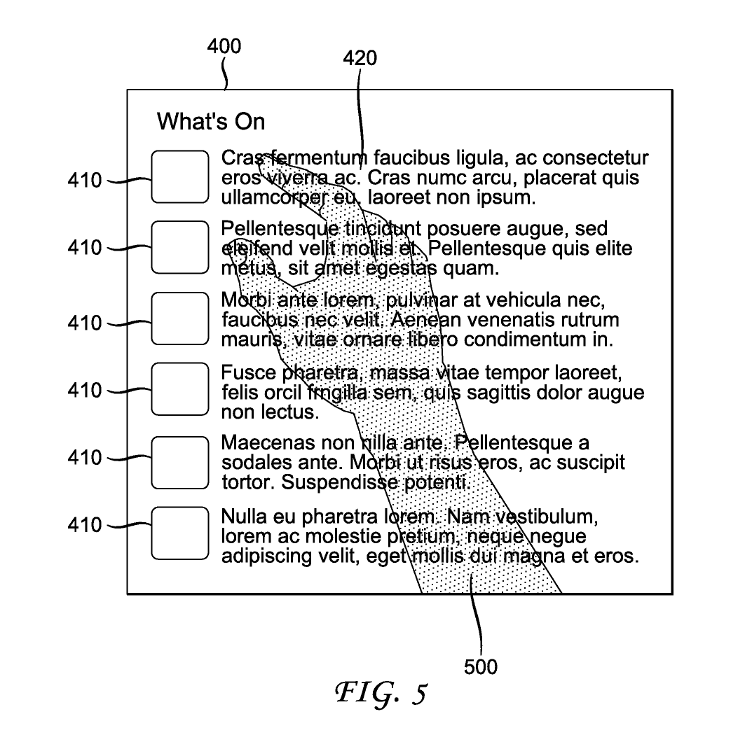

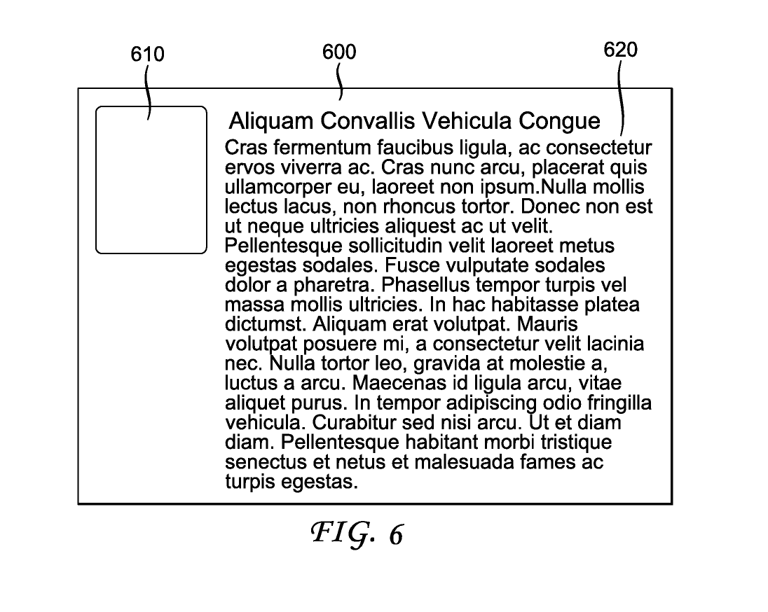

FIG. 4 is a graphical representation of a user interface 400, in this example a program guide that is displayed to a user. The program guide 400 provides a listing of content 410 available for consumption. In this example, selecting the text 420 related to the content of the program guide invokes a details screen. An example of this can be seen in FIGS. 5 and 6.

FIG. 5 depicts the selection of the text 420 relating to the content by a user. In this example, the selection is performed via a touch interface control device 105 wherein the user 500 selects the text 420 by touching the display 120 screen. This in turn causes a details screen 600 to be displayed in the user interface 400 as seen in FIG. 6.

In details screen of FIG. 6, is where the functionality of the present invention is implemented. In this example, not only is additional information and details 610 about the content displayed but elements of the displayed details are selectable for searching. Examples of selectable elements include, but are not limited to, text, pictures, videos, and the like. Other possible selectable elements will be apparent to one skilled in the art given the benefit of this disclosure.

In the example of FIG. 6, the selectable elements of the user interface 400 are part of the text (620) being displayed in the details screen 600, such as an actor's name (e.g. “Johnny Depp”). Alternately, the selectable items could be photos of actors or locations. The implementation of the selectable elements may be performed using know interactive linking techniques, such as hyper-linking or the like. Other possible implementation will be apparent to one skilled in the art given the benefit of this disclosure.

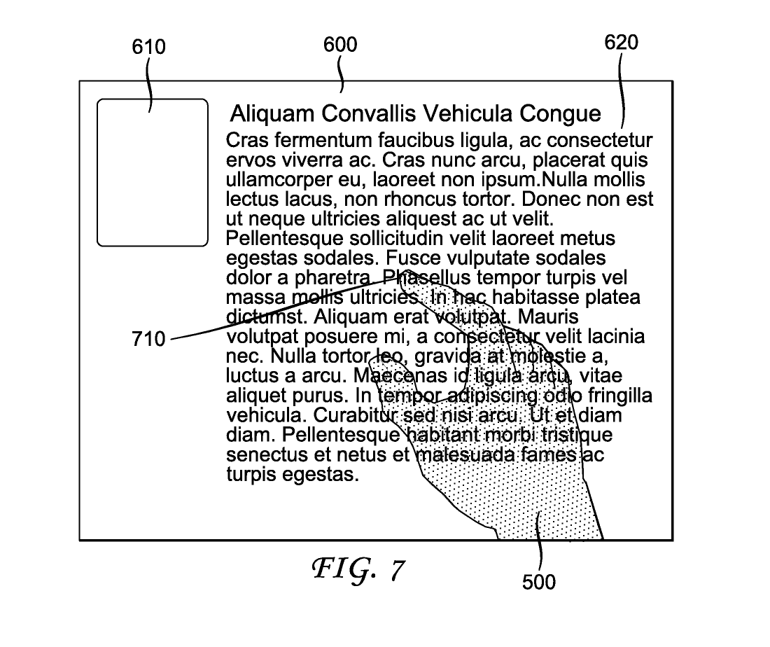

FIG. 7 depicts a user 500 selecting a selectable item, in this example, a word 710 in the text 620 of the details screen 600. In this example, the selection is made via a touch interface control device 105 and is received (step 320) by the processor 200 through the input interface 220. In other embodiments, selection could be made using the navigation keys of a remote control, or a mouse.

Once a selection is received (step 320) the processor initiates a search on the selected element (step 330). The search can be implemented by using traditional search services (Google, Wikipedia, Bing, etc.) by sending a search request to such services through the network connection 240. In one such embodiment, the search is performed in the background so as not to change or otherwise disrupt the context of the currently displayed user interface.

A basic methodology for implementing the invention treating selected item as a keyword. This keyword can then be submitted to an external/internal search engine (Google/Wikipedia/Bing) for matching results. A filtering of results step can then be performed which eliminates results which are not useful to the user. Such filtering can be done based on the type of query used (where certain criteria are used to limit the field of a search to a specific type of media). Filtering of results be also be pre-selected to specify that type of results are to be displayed (i.e. show television shows, movies, and pictures, Wikipedia results, but not web pages). Other approaches of filtering results can be employed, as well and will be apparent to one skilled in the art.

In the case of a photo, such as an actor's photo, an image-recognition layer would be invoked prior to the traditional search, and would bring back results germane to the actor (other photographs, a filmography, interviews, etc.).

In other embodiments, the search may be performed locally, or otherwise limited to content within a closed system. For example, the search can be limited to a service or content provider's database that contains or lists additional content with the same related keyword (e.g. actors name) or photo information.

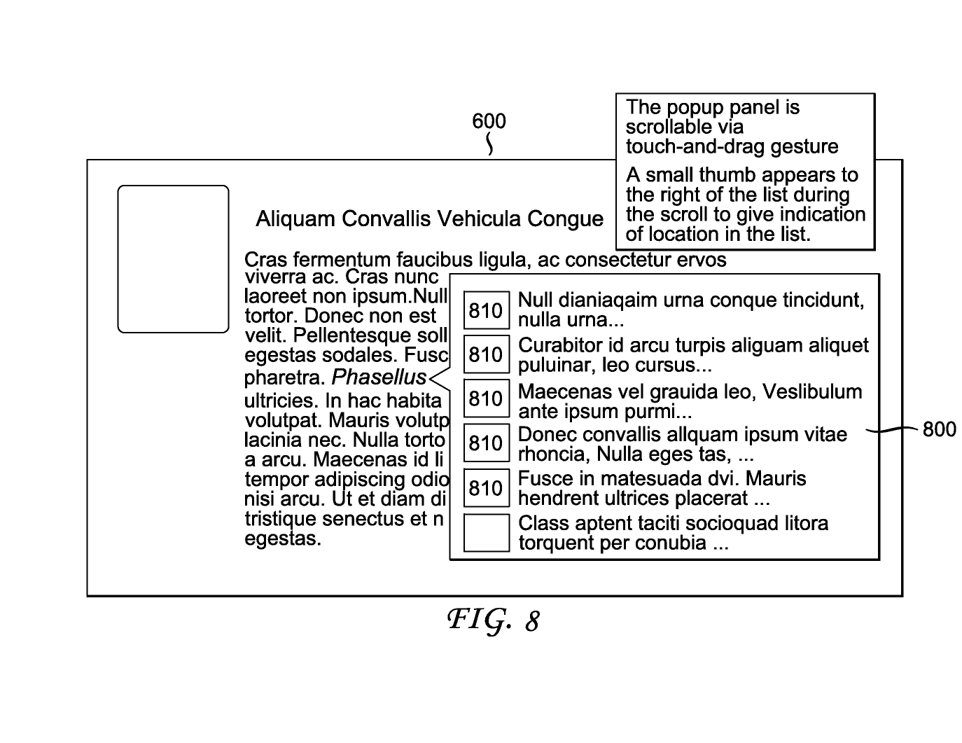

Once the search is performed (step 330) the results of the search can be provided (step 340). In one embodiment, this involves updating the displayed user interface 400 with the results of the search (step 345). An example of this can be seen in FIGS. 8-10.

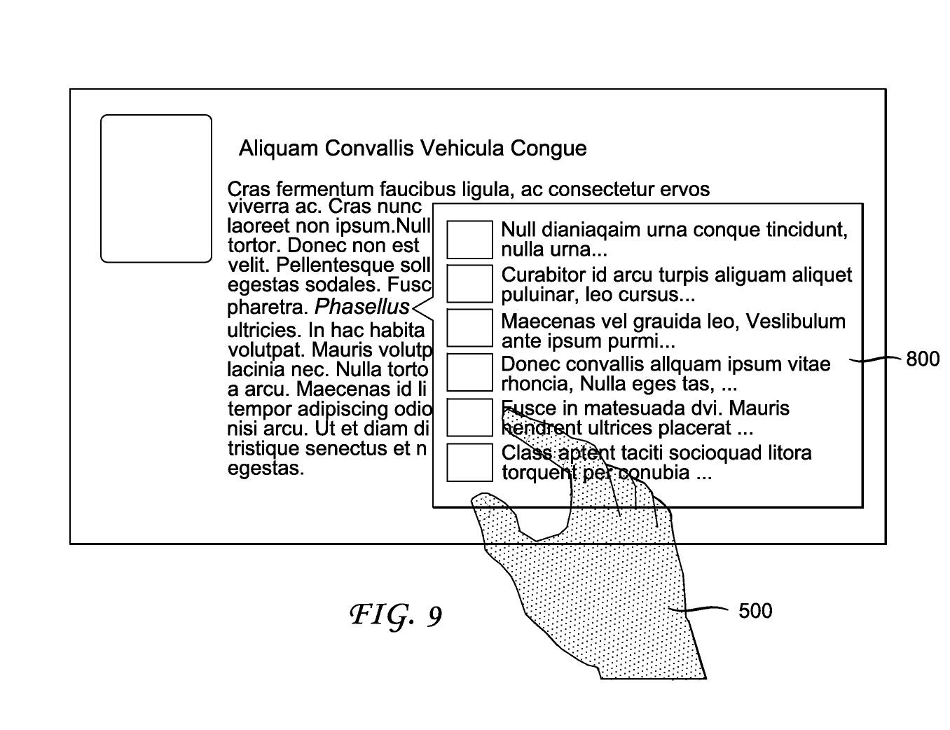

In FIGS. 8 and 9, the results 810 of the search are displayed as a pop-up box within the details screen 600 of the user interface 400. In certain embodiments, the pop-up box allows the user to scroll through the provided results. In some such embodiments, the pop-up box can further provide an indicator or where a user is in the listing of results.

This approach in a general case can be applied to the searching of any list, although it is typically intended that the principles of the invention would apply to the listing of multimedia content. From a listing of content, a user can go into the previously described search mode to find more results that are relevant to the user's interests. With this being the case, if one, for example, considers the results based on the selection of a term, a user can be presented results comprising thumbnails of programs or other content (with related descriptions) that match the keyword that is selected. These results can be scrolled through with the control device.

In some embodiments, the setting of where the query is done can also be relevant to what type of results are to be shown. For example, if a user selects the term that may have multiple meanings “Madonna”, the user can be shown an additional window of potential queries that could be made. For example, if a person were accessing a music application, the selection of the term “Madonna” could bring up a second window that shows “Madonna—Music Artist”/“Lady Madonna—Beatles” The selection of the second query term, would lead to specify results either about Madonna or the song Lady Madonna. Compare this scenario with the selection of the term “Madonna” in an application that presents pictures of art. Instead of seeing pictures of “Madonna, the music artist” you see paintings of “Madonna”, because the query would represent “Madonna+Art” instead of “Madonna+Music” which could be a search query for a musical based application.

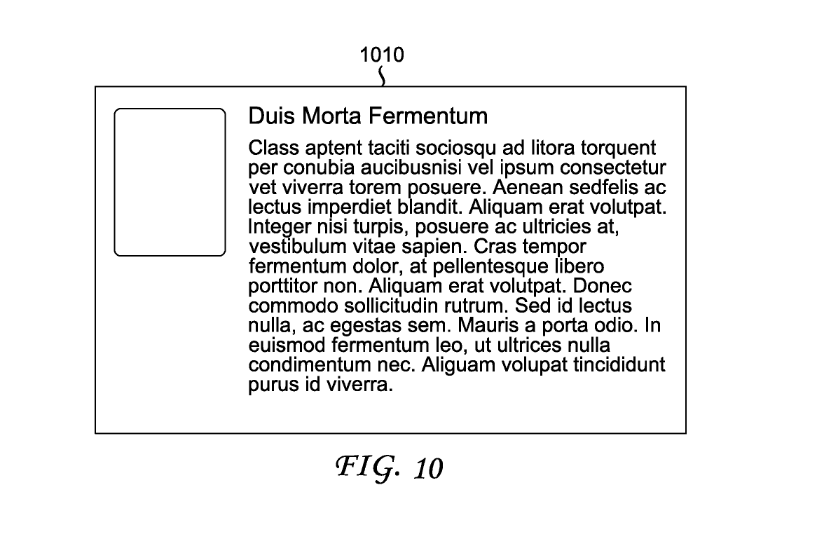

FIG. 9 depicts a user 500 scrolling through the results 810 in the pop-up box 810 and making a selection. In this example, the scrolling and selection is performed via touch interface control device 105. Any selection via the control device 105 is conveyed to the processor 200 through the input interface 220. In response to a selection, a screen showing the details or content related to the selected search result can be generated by the processor 200, outputted by the output interface 230 and displayed on the display device 120 as part of the user interface 400 as shown in FIG. 10. In certain embodiments, this screen 1010 provides the user with the option to view, purchase, record, or otherwise consume the result content.

While the example set forth above has focused on an electronic device, it should be understood that the present invention can also be embedded in a computer program product (e.g. an application), which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

1. A method for searching elements comprising:
providing a user interface comprising one or more selectable elements for display;
receiving a selection of a one of the selectable elements;
performing a search on the selected element; and
providing the results of the search as part of the user interface for display.

2. The method of claim 1, further comprising the step of:
displaying a user interface.

3. The method of claim 2, further comprising the step of:
updating the displayed user interface to display results of the search.

4. The method of claim 1, wherein the user interface comprises an on-screen guide.

5. The method of claim 1, wherein the selection of selectable element is performed using a remote control.

6. The method of claim 1, wherein the selection of selectable element is performed using a touch interface.

7. The method of claim 1, wherein the one or more selectable elements are from the group comprising: text, pictures, and videos.

8. The method of claims 1, wherein the scope of the performed search is based on the context of the one or more selectable elements of the user interface.

9. A system for searching elements comprising:
an output interface configured to output a user interface, the user interface including one or more selectable elements;
an input interface configured to receive a selection of one of the selectable elements;
a processor configured to generate the selectable elements in the user interface, perform a search on a received selection of one of the selectable elements, and provide the results of the search as part of the user interface; and
storage configured to store information regarding the selectable elements, search, and results.

10. The system of claim 9, further comprising a display for displaying the user interface outputted by the output interface.

11. The system of claim 10, wherein the display is part of an electronic device.

12. The system of claim 9, further comprising a control device configured to provide a selection of a selectable element.

13. The media system of claim 12, wherein the control device is part of an electronic device.

14. A computer program product comprising a computer useable medium having a computer readable program, wherein the computer readable program when executed on a computer causes the computer to perform method steps including:
providing a user interface comprising one or more selectable elements for display;
receiving a selection of one of the selectable elements;
performing a search on the selected element; and
providing the results of the search as part of the user interface for display.
